(19) United States
(12) Patent Application Publication
(10) Pub. No.: US 2025/0036389 A1
(43) Pub. Date: Jan. 30, 2025

(54) MULTI-SOURCE DATA CENTER OBJECT MIRRORING IN A MULTI-CLOUD COMPUTING ENVIRONMENT

(71) Applicant: VMWARE, INC., Palo Alto, CA (US)

(72) Inventors: VIPUL PATEL, Bangalore (IN); Ranganayakulu Satteli, Bangalore (IN); Naishadh Vora, Mumbai (IN); Manjunath Bandi, Bangalore (IN); Yashika Deva, Saratoga, CA (US)

(21) Appl. No.: 18/379,690

(22) Filed: Oct. 13, 2023

(30) Foreign Application Priority Data
Jul. 25, 2023 (IN) 202341049986

(51) Int. Cl. G06F 8/65

(52) U.S. Cl. CPC G06F 8/65

(57) ABSTRACT

System and computer-implemented method for managing software objects in a multi-cloud computing environment uses generated sync cycles for infra managers running in at least one cloud of the multi-cloud computing environment, where at least one of the sync cycles for a particular infra manager includes initial and update state information of software objects associated with the particular infra manager. The object updates of the sync cycles are published to an entity in the multi-cloud computing environment, where the object updates are processed and persistently stored in a database for consumption by a service of the entity.

### RELATED APPLICATIONS

Benefit is claimed under 35 U.S.C. 119(a)-(d) to Foreign Application Serial No. 202341049986 filed in India entitled “MULTI-SOURCE DATA CENTER OBJECT MIRRORING IN A MULTI-CLOUD COMPUTING ENVIRONMENT”, on Jul. 25, 2023, by VMware, Inc., which is herein incorporated in its entirety by reference for all purposes.

### BACKGROUND

Cloud architectures are used in cloud computing and cloud storage systems for offering infrastructure-as-a-service (IaaS) cloud services. Examples of cloud architectures include the VMware Cloud architecture software, Amazon EC2™ web service, and OpenStack™ open source cloud computing service. IaaS cloud service is a type of cloud service that provides access to physical and/or virtual resources in a cloud environment. These services provide a tenant application programming interface (API) that supports operations for manipulating IaaS constructs, such as virtual computing instances (VCIs), e.g., virtual machines (VMs), and logical networks.

A cloud system may aggregate the resources from both private and public clouds. A private cloud can include one or more customer data centers (referred to herein as “on-premise data centers”). A public cloud can include a multi-tenant cloud architecture providing IaaS cloud services. In a cloud system, it is desirable to support VCI migration between different private clouds, between different public clouds and between a private cloud and a public cloud for various reasons, such as workload management.

In order to manage the VCIs and other software objects, there is a need to have visibility into the state of these software objects at a central location, which may be at any private or public cloud.

### SUMMARY

System and computer-implemented method for managing software objects in a multi-cloud computing environment uses generated sync cycles for infra managers running in at least one cloud of the multi-cloud computing environment, where at least one of the sync cycles for a particular infra manager includes initial and update state information of software objects associated with the particular infra manager. The object updates of the sync cycles are published to an entity in the multi-cloud computing environment, where the object updates are processed and persistently stored in a database for consumption by a service of the entity.

A computer-implemented method for managing software objects in a multi-cloud computing environment in accordance with an embodiment of the invention comprises generating sync cycles for infra managers running in at least one cloud of the multi-cloud computing environment, at least one of the sync cycles for an infra manager including initial and update state information of software objects associated with the infra manager, persistently storing object updates of the sync cycles for the infra managers in a first database, publishing the object updates of the sync cycles to an entity of the multi-cloud computing environment, processing the object updates of the sync cycles at the entity based on the infra managers to produce resultant object updates, and persistently storing the resultant object updates in a second database for consumption by a service of the entity. In some embodiments, the steps of this method are performed when program instructions contained in a computer-readable storage medium are executed by one or more processors.

A system in accordance with an embodiment of the invention comprises memory and one or more processors configured to generate sync cycles for infra managers running in at least one cloud of the multi-cloud computing environment, at least one of the sync cycles for an infra manager including initial and update state information of software objects associated with the infra manager, persistently store object updates of the sync cycles for the infra managers in a first database, publish the object updates of the sync cycles to an entity of the multi-cloud computing environment, process the object updates of the sync cycles at the entity based on the infra managers to produce resultant object updates, and persistently store the resultant object updates in a second database for consumption by a service of the entity.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a cloud system in which embodiments of the invention may be implemented.

FIG. 2 shows components of a mirroring system in the cloud system depicted in FIG. 1 in accordance with an embodiment of the invention.

FIG. 3 illustrates a control channel and a data channel used by the mirroring system in accordance with an embodiment of the invention.

FIG. 4 shows components of a replicator of the mirroring system in accordance with an embodiment of the invention.

FIG. 5 illustrates a state machine for an inventory publisher of the mirroring system in accordance with an embodiment of the invention.

FIG. 6 shows components of the inventory publisher of the mirroring system in accordance with an embodiment of the invention.

FIG. 7 is a diagram of a replication process showing an end-to-end flow of control and data messages in accordance with an embodiment of the invention.

FIG. 8 is a process flow diagram of a computer-implemented method for managing software objects in a multi-cloud computing environment in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

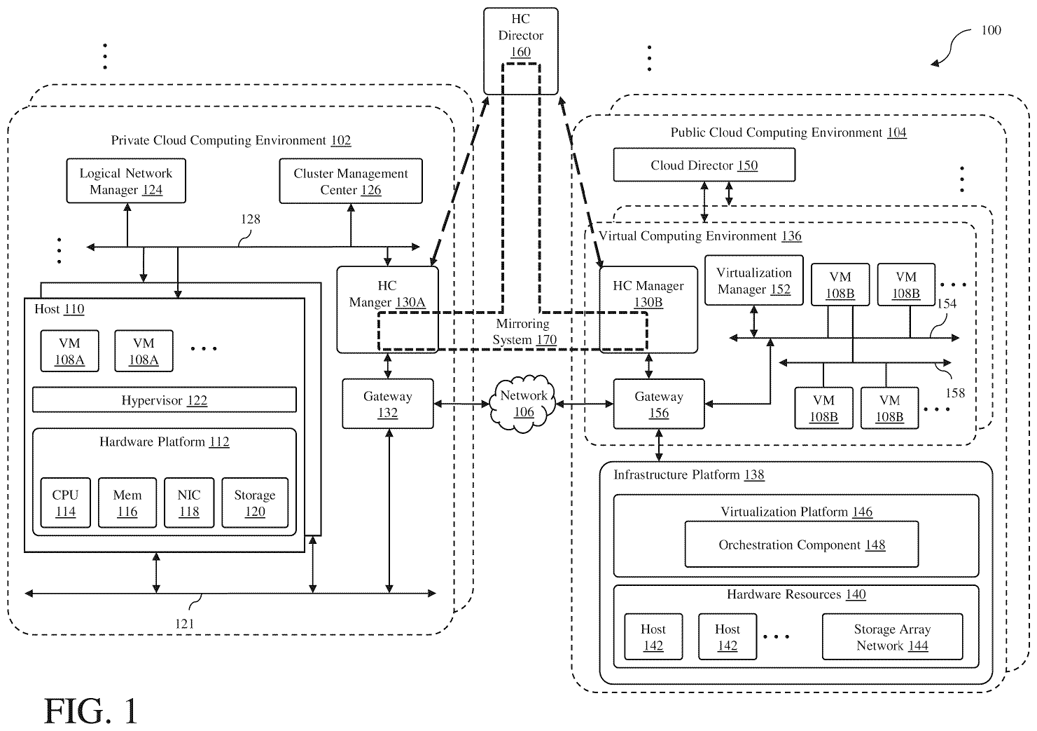

Turning now to FIG. 1, a block diagram of a cloud system 100 in which embodiments of the invention may be implemented in accordance with an embodiment of the invention is shown. The cloud system 100 includes one or more private cloud computing environments 102 and one or more public cloud computing environments 104 that are connected via a network 106. The cloud system 100 is configured to provide a common platform for managing and executing workloads seamlessly between the private and public cloud computing environments. Thus, the cloud system 100 is a multi-cloud computing environment. In one embodiment, one or more private cloud computing environments 102 may be controlled and administrated by a particular enterprise or business organization, while one or more public cloud computing environments 104 may be operated by a cloud computing service provider and exposed as a service available to account holders, such as the particular enterprise in addition to other enterprises. In some embodiments, one or more private cloud computing environments 102 may form a private or on-premise software-defined data center (SDDC). In other embodiments, the on-premise SDDC may be extended to include one or more computing environments in one or more public cloud computing environments 104. Thus, as used herein, SDDCs refers to SDDCs that are formed from multiple cloud computing environments, which may be form by multiple private cloud computing environments, multiple public cloud computing environments or any combination of private and public cloud computing environments.

The private and public cloud computing environments 102 and 104 of the cloud system 100 include computing and/or storage infrastructures to support a number of virtual computing instances 108A and 108B. As used herein, the term “virtual computing instance” refers to any software processing entity that can run on a computer system, such as a software application, a software process, a virtual machine (VM), e.g., a VM supported by virtualization products of VMware, Inc., and a software “container”, e.g., a Docker container. However, in this disclosure, the virtual computing instances will be described as being virtual machines, although embodiments of the invention described herein are not limited to virtual machines.

In an embodiment, the cloud system 100 supports migration of the virtual machines 108A and 108B between any of the private and public cloud computing environments 102 and 104. The cloud system 100 may also support migration of the virtual machines 108A and 108B between different sites situated at different physical locations, which may be situated in different private and/or public cloud computing environments 102 and 104 or, in some cases, the same computing environment.

As shown in FIG. 1, each private cloud computing environment 102 of the cloud system 100 includes one or more host computer systems (“hosts”) 110. The hosts may be constructed on a server grade hardware platform 112, such as an x86 architecture platform. As shown, the hardware platform of each host may include conventional components of a computing device, such as one or more processors (e.g., CPUs) 114, system memory 116, a network interface 118, storage system 120, and other I/O devices such as, for example, a mouse and a keyboard (not shown). The processor 114 is configured to execute instructions, for example, executable instructions that perform one or more operations described herein and may be stored in the memory 116 and the storage 120. The memory 116 is volatile memory used for retrieving programs and processing data. The memory 116 may include, for example, one or more random access memory (RAM) modules. The network interface 118 enables the host 110 to communicate with another device via a communication medium, such as a network 121 within the private cloud computing environment. The network interface 118 may be one or more network adapters, also referred to as a Network Interface Card (NIC). The storage 120 represents local storage devices (e.g., one or more hard disks, flash memory modules, solid state disks and optical disks), which may be used as part of a virtual storage area network.

Each host 110 may be configured to provide a virtualization layer that abstracts processor, memory, storage and networking resources of the hardware platform 112 into the virtual computing instances, e.g., the virtual machines 108A, that run concurrently on the same host. The virtual machines run on top of a software interface layer, which is referred to herein as a hypervisor 122, that enables sharing of the hardware resources of the host by the virtual machines. One example of the hypervisor 122 that may be used in an embodiment described herein is a VMware ESXi™ hypervisor provided as part of the VMware vSphere® solution made commercially available from VMware, Inc. The hypervisor 122 may run on top of the operating system of the host or directly on hardware components of the host. For other types of virtual computing instances, the host may include other virtualization software platforms to support those virtual computing instances, such as Docker virtualization platform to support software containers.

Each private cloud computing environment 102 includes at least one logical network manager 124 (which may include a control plane cluster), which operates with the hosts 110 to manage and control logical overlay networks in the private cloud computing environment 102. As illustrated, the logical network manager communicates with the hosts using a management network 128. In some embodiments, the private cloud computing environment 102 may include multiple logical network managers that provide the logical overlay networks. Logical overlay networks comprise logical network devices and connections that are mapped to physical networking resources, e.g., switches and routers, in a manner analogous to the manner in which other physical resources as compute and storage are virtualized. In an embodiment, the logical network manager 124 has access to information regarding physical components and logical overlay network components in the private cloud computing environment 102. With the physical and logical overlay network information, the logical network manager 124 is able to map logical network configurations to the physical network components that convey, route, and filter physical traffic in the private cloud computing environment. In a particular implementation, the logical network manager 124 is a VMware NSX® Manager™ product running on any computer, such as one of the hosts 110 or VMs 108A in the private cloud computing environment 102.

Each private cloud computing environment 102 also includes at least one cluster management center (CMC) 126 that communicates with the hosts 110 via the management network 128. In an embodiment, the cluster management center 126 is a computer program that resides and executes in a computer system, such as one of the hosts 110, or in a virtual computing instance, such as one of the virtual machines 108A running on the hosts. One example of the cluster management center 126 is the VMware vCenter Server® product made available from VMware, Inc. The cluster management center 126 is configured to carry out administrative tasks for the private cloud computing environment 102, including managing the hosts in one or more clusters, managing the virtual machines running within each host, provisioning virtual machines, deploying virtual machines, migrating virtual machines from one host to another host, and load balancing between the hosts.

Each private cloud computing environment 102 further includes a hybrid cloud (HC) manager 130A that is configured to manage and integrate computing resources provided by the private cloud computing environment 102 with computing resources provided by one or more of the public cloud computing environments 104 to form a unified “hybrid” computing platform. The hybrid cloud manager is responsible for migrating/transferring virtual machines between the private cloud computing environment and one or more of the public cloud computing environments, and perform other “cross-cloud” administrative tasks. In one implementation, the hybrid cloud manager 130A is a module or plug-in to the cluster management center 126, although other implementations may be used, such as a separate computer program executing in any computer system or running in a virtual machine in one of the hosts 110. One example of the hybrid cloud manager 130A is the VMware® HCX™ product made available from VMware, Inc.

In one embodiment, the hybrid cloud manager 130A is configured to control network traffic into the network 106 via a gateway device 132, which may be implemented as a virtual appliance. The gateway device 132 is configured to provide the virtual machines 108A and other devices in the private cloud computing environment 102 with connectivity to external devices via the network 106. The gateway device 132 may manage external public Internet Protocol (IP) addresses for the virtual machines 108A and route traffic incoming to and outgoing from the private cloud computing environment and provide networking services, such as firewalls, network address translation (NAT), dynamic host configuration protocol (DHCP), load balancing, and virtual private network (VPN) connectivity over the network 106.

Each public cloud computing environment 104 of the cloud system 100 is configured to dynamically provide an enterprise (or users of an enterprise) with one or more virtual computing environments 136 in which an administrator of the enterprise may provision virtual computing instances, e.g., the virtual machines 108B, and install and execute various applications in the virtual computing instances. Each public cloud computing environment includes an infrastructure platform 138 upon which the virtual computing environments can be executed. In the particular embodiment of FIG. 1, the infrastructure platform 138 includes hardware resources 140 having computing resources (e.g., hosts 142), storage resources (e.g., one or more storage array systems, such as a storage area network 144), and networking resources (not illustrated), and a virtualization platform 146, which is programmed and/or configured to provide the virtual computing environments 136 that support the virtual machines 108B across the hosts 142. The virtualization platform may be implemented using one or more software programs that reside and execute in one or more computer systems, such as the hosts 142, or in one or more virtual computing instances, such as the virtual machines 108B, running on the hosts.

In one embodiment, the virtualization platform 146 includes an orchestration component 148 that provides infrastructure resources to the virtual computing environments 136 responsive to provisioning requests. The orchestration component may instantiate virtual machines according to a requested template that defines one or more virtual machines having specified virtual computing resources (e.g., compute, networking and storage resources). Further, the orchestration component may monitor the infrastructure resource consumption levels and requirements of the virtual computing environments and provide additional infrastructure resources to the virtual computing environments as needed or desired. In one example, similar to the private cloud computing environments 102, the virtualization platform may be implemented by running on the hosts 142 VMware ESXi™-based hypervisor technologies provided by VMware, Inc. However, the virtualization platform may be implemented using any other virtualization technologies, including Xen®, Microsoft Hyper-V® and/or Docker virtualization technologies, depending on the virtual computing instances being used in the public cloud computing environment 104.

In one embodiment, each public cloud computing environment 104 may include a cloud director 150 that manages allocation of virtual computing resources to an enterprise. The cloud director may be accessible to users via a REST (Representational State Transfer) API (Application Programming Interface) or any other client-server communication protocol. The cloud director may authenticate connection attempts from the enterprise using credentials issued by the cloud computing provider. The cloud director receives provisioning requests submitted (e.g., via REST API calls) and may propagate such requests to the orchestration component 148 to instantiate the requested virtual machines (e.g., the virtual machines 108B). One example of the cloud director is the VMware vCloud Director® product from VMware, Inc. The public cloud computing environment 104 may be VMware cloud (VMC) on Amazon Web Services (AWS).

In one embodiment, at least some of the virtual computing environments 136 may be configured as SDDCs. Each virtual computing environment includes one or more virtual computing instances, such as the virtual machines 108B, and one or more cluster management centers 152. The cluster management centers 152 may be similar to the cluster management center 126 in the private cloud computing environments 102. One example of the cluster management center 152 is the VMware vCenter Server® product made available from VMware, Inc. Each virtual computing environment may further include one or more virtual networks 154 used to communicate between the virtual machines 108B running in that environment and managed by at least one networking gateway device 156, as well as one or more isolated internal networks 158 not connected to the gateway device 156. The gateway device 156, which may be a virtual appliance, is configured to provide the virtual machines 108B and other components in the virtual computing environment 136 with connectivity to external devices, such as components in the private cloud computing environments 102 via the network 106. The gateway device 156 operates in a similar manner as the gateway device 132 in the private cloud computing environments. In some embodiments, each virtual computing environment may further include components found in the private cloud computing environments 102, such as the logical network managers, which are suitable for implementation in a public cloud.

In one embodiment, each virtual computing environments 136 includes a hybrid cloud (HC) manager 130B configured to communicate with the corresponding hybrid cloud manager 130A in at least one of the private cloud computing environments 102 to enable a common virtualized computing platform between the private and public cloud computing environments. The hybrid cloud director 130B may communicate with the hybrid cloud manager 130A using Internet-based traffic via a VPN tunnel established between the gateways 132 and 156, or alternatively, using a direct connection (not shown), which may be an AWS Direct Connect connection. The hybrid cloud manager 130B and the corresponding hybrid cloud manager 130A facilitate cross-cloud migration of virtual computing instances, such as virtual machines 108A and 108B, between the private and public computing environments. This cross-cloud migration may include “cold migration”, which refers to migrating a VM which is always powered off throughout the migration process, “hot migration”, which refers to live migration of a VM where the VM is always in powered on state without any disruption, and “bulk migration”, which is a combination where a VM remains powered on during the replication phase but is briefly powered off, and then eventually turned on at the end of the cutover phase. The hybrid cloud managers in different computing environments, such as the private cloud computing environment 102 and the virtual computing environment 136, operate to enable migrations between any of the different computing environments, such as between private cloud computing environments, between public cloud computing environments, between a private cloud computing environment and a public cloud computing environment, between virtual computing environments in one or more public cloud computing environments, between a virtual computing environment in a public cloud computing environment and a private cloud computing environment, etc. As used herein, “computing environments” include any computing environment, including data centers. As an example, the hybrid cloud manager 130B may be a component of the HCX-Enterprise product, which is provided by VMware, Inc.

As shown in FIG. 1, the cloud system 100 further includes a hybrid cloud (HC) director 160, which communicates with multiple hybrid cloud (HC) managers, such as the HC managers 130A and 130B. The HC director 160 aims to enhance operational efficiency by providing a single pane of glass to enable planning and orchestration of workload migration activities across multiple sites, e.g., the private cloud computing environment 102 the virtual computing environment 136, which operate as software-defined data centers (SDDCs). As noted above, SDDCs may be formed by multiple private cloud computing environments, such as the private cloud computing environments, multiple public cloud computing environments, such as the virtual computing environments 136 and a combination of private and public computing environments. These SDDCs may be operated by various tenants, where each tenant may operate multiple SDDCs. The orchestration activities operate on software objects of the SDDCs, and hence, intents to the HC director may be stated in terms of one or more objects, which include, but not limited to, VMs, network objects, storage objects, edge objects, etc. These objects may reside inside or be managed by the infrastructure (infra) managers of the SDDCs, such as the logical network manager 124 and the cluster management center 126. Hence, the HC director needs to have visibility into the state of SDDC objects to enable centralized orchestration. The objects residing in different sources of SDDCs (or multi-source data center objects) undergo changes over time and their state needs to be reflected in the HC director at the earliest to drive business workflows. Each SDDC source churns object changes concurrently, and thus, there is a need for an efficient way to allow mirroring these objects streams to the far end HC director. However, since the HC director is a service, which may reside in a remote cloud, the HC director may not be able to periodically pull object updates to construct a view of the SDDCs. Thus, as illustrated in FIG. 1, the cloud system 100 includes a scalable mirroring system 170, which performs such a mirroring function. The need for the mirroring system arises from the fact that object streams from multiple SDDCs/sites belonging to several tenants may need to be ingested at the same time.

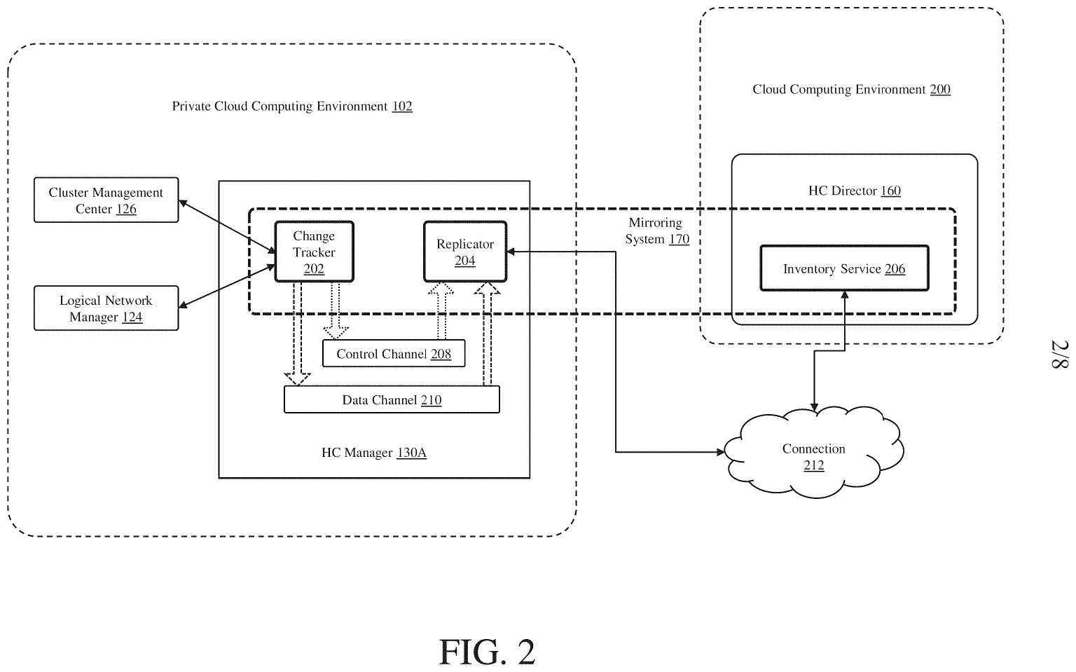

Turning now to FIG. 2, components of the mirroring system 170 in the cloud system 100 in accordance with an embodiment of the invention are illustrated. The mirroring system components are included in hybrid cloud managers, such as the hybrid cloud manager 130A, and the hybrid cloud director (HCD) 160. The mirroring system components include a change tracker 202 and a replicator 204, which are included in each hybrid cloud manager, and an inventory service 206, which is included in the hybrid cloud director 160. In FIG. 2, only the mirroring system components in the hybrid cloud manager 130A are shown. Other hybrid cloud managers in the cloud system 100 includes the same mirroring system components.

The overall goal of the monitoring system 170 is to capture the state of the data center objects (i.e., objects in the SDDCs) and the changes happening on these objects, and to propagate the captured information to the HC director 160, which may reside in a separate cloud computing environment 200. The cloud computing environment 200 may reside in a private or public cloud. Since the data center objects are scattered across different data center compute and networking infrastructure management entities, such as the logical network manager (LNM) 124 and the cluster management center (CMC) 126, the monitoring system needs a mechanism to capture, identify and track the object changes that are specific to the entity that hosts these objects. These infrastructure management entities will sometimes be referred to herein as infra managers, which host and manage various data center objects, e.g., VMs or other software components deployed in the SDDC.

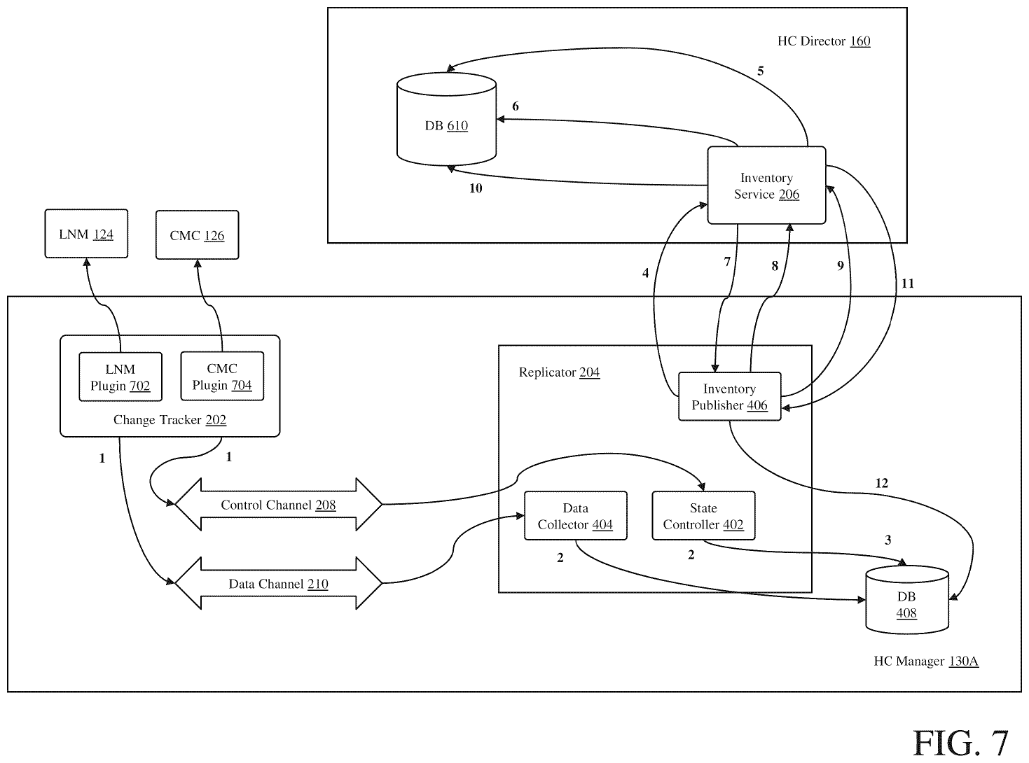

The change tracker 202 of the monitoring system 170 is configured to track changes of the data center objects across various infra managers. The goal of the change tracker is to abstract out the external system-specific anomaly and present object changes in a normalized form suitable for further processing in the replication or mirroring pipeline of the mirroring system. The change tracker encapsulates a set of pluggable modules (i.e., plugins 702 and 704 shown FIG. 7) that are specific to the infra manager with which the change tracker interacts. As an example, there is one plugin for the logical network manager 124 and another plugin for the cluster management center 126.

Each plugin running in the change tracker 202 for an infra manager is customized to understand the tracking mechanisms offered by that infra manager. The plugin taps the object changes and converts the object changes into a uniform format suitable for consumption by the replicator 204, which is described below.

Each plugin starts to track changes by capturing an initial state of all the objects (i.e., a snapshot) managed by an infra manager and then capturing the delta changes subsequently. The initial object set, and the series of delta changes thereon are referred to as an “Epic”, which can be viewed as a synchronization (synch) cycle. The plugin will start new Epics in the following scenarios to get a fresh view of the current state of the objects:
1. When the change tracker 202 comes back up post restart
2. When an infra manager, e.g., the logical network manager (LNM) 124 or the cluster management center (CMC) 126, remains unreachable from the change tracker for a prolonged period, which may be predefined.

Each Epic is exclusive to a particular infra manager (e.g., the LNM 124 or the CMC 126) and carries inventory objects of that infra manager. The properties of an Epic in accordance with an embodiment of the invention are listed in a table shown below. These properties include an EPIC identification (ID), a start time, an infra manager ID and an end time. Each ID may include a Universally Unique Identifier (UUID).

| Sr# | Property | Description |
|---|---|---|
| 1 | EPIC ID | UUID to uniquely identify sync cycle |
| 2 | Start Time | The timestamp when the sync cycle started |
| 3 | Entity ID | ID of the datacenter infra manager (e.g., LNM, CMC) whose objects are being |
| | | synced as part of a particular Epic/sync cycle |
| 4 | End Time | The timestamp when sync cycle concluded |

Each Epic consists of a series of object updates that carry objects in their entirety during the initial sync or incremental updates during the delta sync phase. Every inventory update is modelled as an object having a series of properties. This allows the mirroring system to capture the state of the object when it is observed for the first time or is found to have been modified. The schematic of the object is as shown below:

Object {
Properties: {
Set: {
Key1: Value1,
Key2: Value2,
.............
}
Unset: {
Key3: Value3,
Key4: Value4,
.............
}
}
}

The object updates are also referred to herein as inventory object changesets. The properties of an inventory object set in accordance with an embodiment of the invention are listed in the following table.

| Sr# | Property | Description |
|---|---|---|
| 1 | Changeset ID | This is an incremental unique number tagged to every object update. This helps |
| | | keep track of changesets which are delivered and making sure updates are |
| | | processed in the right order. The change set ID of each object update changeset |
| | | are unique in the context of a given Epic. |
| 2 | EPIC ID | Identifies the sync cycle to which this object update belongs |
| 3 | Object Type | The type of object in a data center. Examples: virtual machine, storage, |
| | | datastore, segment, network etc. |
| 4 | Object ID | This refers to an ID of an object as they appear in the data center. Examples: |
| | | vm-123, network-567 etc. |
| 5 | Change Type | Identifies type of object update: |
| | | Create - When an object is being synced for the first time |
| | | Modify - To convey differential update on an object |
| | | Delete - To convey that object no longer exists in the data center |
| 6 | Object | This contains an actual object update. ‘Set’ specifies a valid set of attributes |
| | −> Set | along with its values at the time of observing changes on an object. ‘Unset’ |
| | −> Unset | specifies a set of attributes of an object which are no longer associated to an |
| | | object |
| | | For the change type = Create only ‘Set’ will be available. |
| | | For the change type = Create only ‘Set’ specifies a set of attributes with |
| | | updated values or newly added attribute to an object while ‘Unset’ specifies |
| | | attributes disassociated from an object |

Every sync cycle, or “Epic”, goes through the following distinct phases:
1. Sync cycle starts—Conveys Epic cycle ID, timestamp and the identity of data center entity/infra manager to which this sync cycle pertains
2. Initial/Full sync—A stream of object sets in their entirety to build the initial state on the public cloud side.
3. Mark end of initial sync of object sets—To flag that all the initial objects are synced, and further updates will be sent as differential changes.
4. Delta sync—A stream of object change sets to convey differential changes observed on the object since last update.
5. Sync cycle ends—Signifies Epic with a particular ID has concluded along with the timestamp.

The change tracker 202 of the monitoring system 170 conveys the lifecycle of an Epic to the replicator component over a control channel 208, while the actual object updates of an epic are relayed over a data channel 210. When a new Epic starts, earlier mirrored objects become invalid. The change tracker flags the start of a new Epic by sending a special control signal on the control channel. Similarly, older Epics are marked completed by sending “end epic” control signals. Here, a control channel is used to convey the lifecycle of Epics. The actual object changes are sent over the data channel in the form of object changesets. The specifics of messages sent over control and data channels are described below.

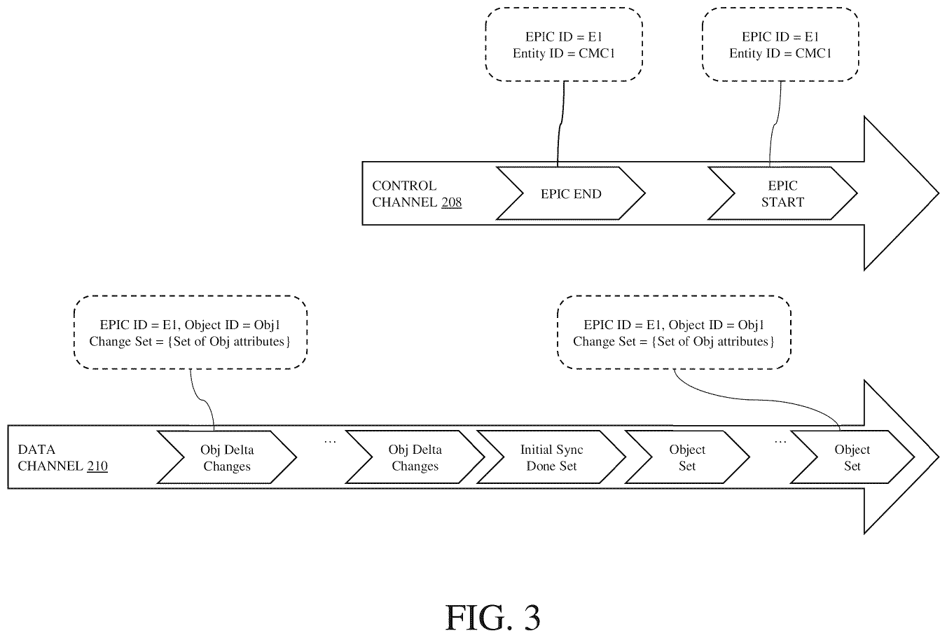

FIG. 3 illustrates the control channel 208 and the data channel 210 used by the mirroring system 170 in accordance with an embodiment of the invention. As shown in FIG. 3, the control channel 208 is used to carry important information when a sync starts and ends for a particular infra manager entity of the data center 102, such as the LNM 124 or the CMC 126. As an example, the control channel is used to send the Epic ID and the Entity ID for Epic starts and ends. The data channel 210 is used to carry actual object changes. As an example, the data channel is used to send the Epic ID, the Object ID and the Change Set for Object Set and Object Delta Changes. In an embodiment, the mirroring system 170 allows syncing multiple object streams of various datacenter entities in parallel, where each stream has its own epic identity.

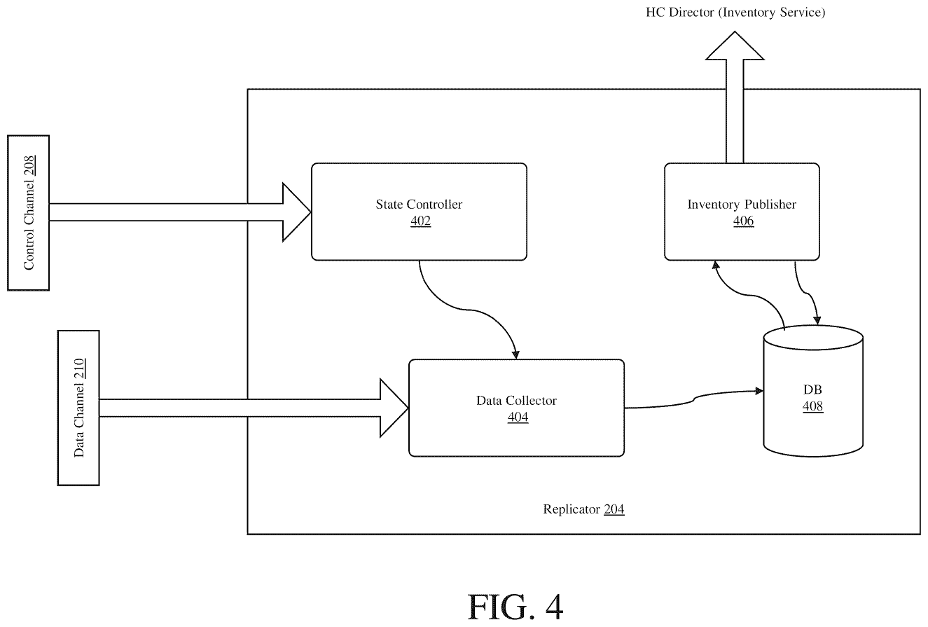

The replicator 204 of the monitoring system 170 works in tandem with control and data signals produced by the change tracker 202. The replicator is configured to (1) observe start/end of replication or synch cycles (“Epics”) for an infra manager notified by the change tracker, (2) receive object changes emitted by the change tracker and stage the object changes. (3) publish to the HC director 160 (i.e., the inventory service 206) using a connection 212, which may be a connection through the network 106 or a direct connection, with guaranteed delivery using retransmission of missing changes, and (4) act as a rate limiter when object changes are produced at the rapid rate. FIG. 4 shows components of the replicator that perform these functions in accordance with an embodiment of the invention. As shown in FIG. 4, the replicator includes a state controller 402, an data collector 404 and a publisher 406.

The state controller 402 of the replicator 204 operates to tune into the control channel 208 and listen for Epic lifecycle events to get insight into the start or end of a replication cycle for a particular infra manager, such as the LNM 124 or the CMC 126. The state controller needs to govern the replication of multiple object streams as the data center 102 can have more than one infra manager (e.g., multiple LNMs and/or multiple CMCs). The state controller controls the working of the other two components of the replicator 204, i.e., the data collector 404 and the publisher 406. The state controller maintains information about each active Epic cycle, which includes the identification of the infra manager/entity to which stream belongs and the start time of the Epic cycle.

The data collector 404 of the replicator 204 is responsible for pulling object updates from the data channel 210 and stage them in a persistent database 408 to be sent to the HC director 160 subsequently. The data collector prefetches object updates from the data channel into the database 408 making sure the inventory publisher 406 has data available to be sent to the HC director 160. The state controller 402 instantiates an instance of the data collector when the state controller learns about a new Epic via the control channel 208. Similarly, the data collector 404 is stopped by the state controller when a corresponding Epic sync cycle has concluded. The data collector fetches object updates pertaining to allotted Epic ID only from the data channel 210.

The inventory publisher 406 of the replicator 204 operates to pull prefetched object updates from the database 408 and publishes them to the HC director 160. The responsibilities of the publisher may include (a) notifying the HC director of sync cycle lifecycle events to prepare the HC director to accept new updates or invalid data already synched as part of previous sync cycles, (b) adjusting impedance mismatch between the change tracker 202 and the HC director 160 (i.e., mismatch between the rate of the change tracker capturing object changes and the rate of the HC director receiving and processing the object changes), and (c) retransmitting object updates missed during the transit.

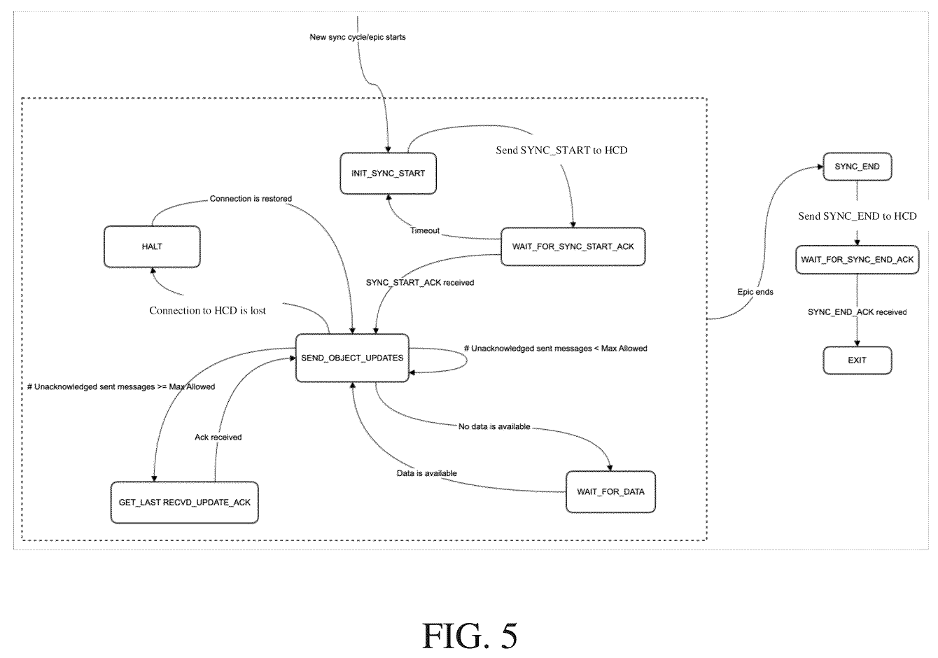

The inventory publisher 406 works in accordance with a state machine depicted in FIG. 5 in accordance with an embodiment of the invention. The inventory publisher operates in a burst mode where the inventory publisher sends a set of object updates to the HC director (HCD) 160 before the inventory publisher waits for an acknowledgement from the HC director for the identification of object update most recently received by the HC director. The inventory publisher pauses when no object update is available and swings into action as soon as the data collector 404 prefetches object updates.

To ensure consistency of data at the HC director 160, the inventory publisher 406 needs to know the last message successfully processed at the HC director 160 to appropriately select the message to be sent next. Soliciting explicit acknowledgement for every object sent will add to the overall latency and slow down the object syncing process. Hence, the inventory publisher operate in a burst mode, sending multiple objects before waiting for an acknowledgement. Also, the aim should be to minimize initial latency after an object update is captured by the change tracker 202. To fulfill these requirements, the replicator 204 and the HC director 160 operate in tandem with the parameters described below:
PUBLISHED_CHANGESET=ChangesetID of the object update sent to the HC director 160 by the replicator 204.
ACKNOWLEDGED_CHANGESET=ChangesetID of the object update acknowledged by the HC director 160.
MAX_ALLOWED_UNACKNOWLEDGED_CHANGESETS=The maximum number of object updates that the inventory publisher 406 can send to the HC director 160 without waiting for an acknowledgement. This allows the replicator 204 to pump changes at a rapid rate and avoid round-trip latency if every object update was acknowledged.
MAX_ALLOWED_PREFETCHED_CHANGESETS=The number of objects changesets that data collector 404 should prefetch into the persistence layer, i.e., the database 408, from the data channel 210 before the object changesets could be published to the HC director 160. Typically, MAX_ALLOWED_PREFETCHED_CHANGESETS>MAX_ALLOWED_UNACKNOWLEDGED_CHANGESETS to allow concurrent retrieval of object updates from the data channel 210 and the publishing to the HC director 160.
PUBLISHED_CHANGESET−ACKNOWLEDGED_CHANGESET)<=MAX_ALLOWED_UNACKNOWLEDGED_CHANGESETS

The inventory service 206 in the HC director 160 is a subsystem of the mirroring system 170 that resides in the HC director. The inventory service is responsible for ingesting the control and data messages relayed by the replicator 204 of one or more HC managers 130, which may be running in multiple sites belonging to various tenants. This component is multi-tenant and provides tenant isolation while ingesting and storing inventory object update messages.

The inventory service 206 keeps track of one more active sync cycles originating from one or more sites and accepts and processes update messages accordingly. The inventory service also maintains detailed information on the last successfully processed message of every sync cycle to help the replicator 204 perform the required retransmissions of the lost messages. The incoming object update is subjected to the transformation rules, if defined, and the resultant object updates are persisted in a database for the further consumption by the other HC director services for orchestration, such as workload migration service.

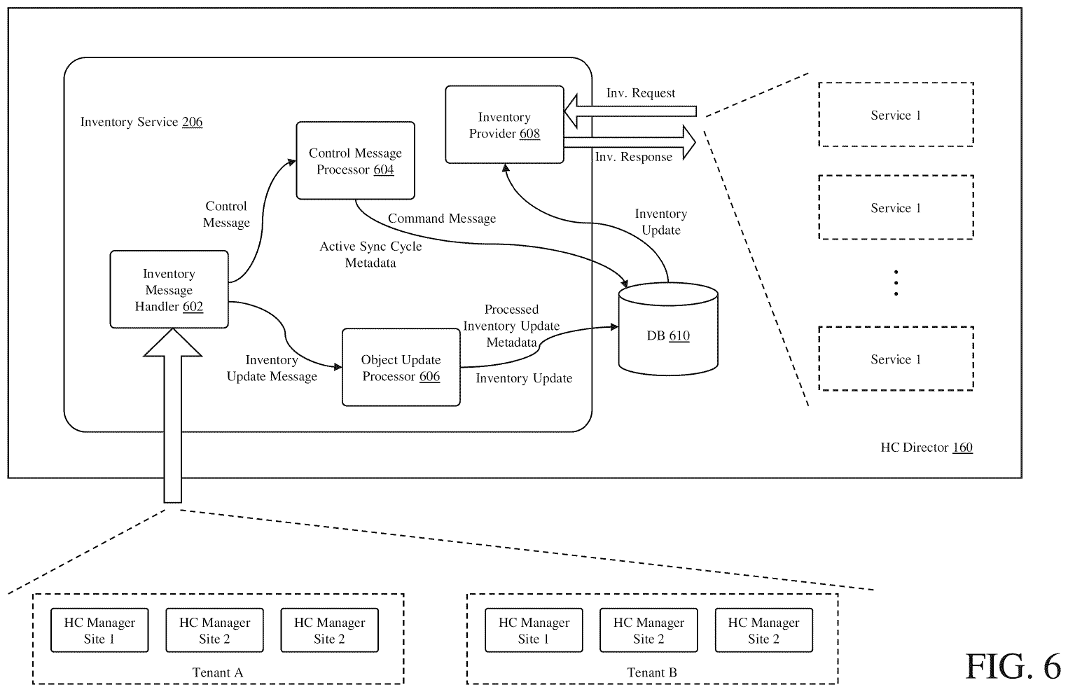

FIG. 6 shows components of the inventory service 206 in accordance with an embodiment of the invention. As shown in FIG. 6, the inventory service includes an inventory message handler 602, a control message processor 604, an object update processor 606 and an inventory provider 608.

The inventory message handler 602 receives control and data messages from various HC managers in different sites, such as sites 1, 2 and 3, for different tenants, such as tenants A and B. Depending on the received messages, the inventory message handler generates control messages for the control message processor and inventory update messages for the object update processor. The control messages may include messages regarding start and end of sync cycles. The inventor update messages includes messages for inventory updates for particular infra managers running on the different sites.

The control message processor 604 operates to process the control messages in order to store command messages and active sync cycle metadata in a persistent database 610. The command messages may include a message to invalidate inventory in case of new sync cycle begins and a message to purge inventory of decommissioned infra managers. The active sync cycle metadata may include information about new sync cycle for a given infra manager in a site.

The object update processor 606 operates to process the inventory update messages in order to store inventory updates and the associated inventory update metadata in the persistent database 610. In an embodiment, the object update processor 606 uses transformation rules or object mapper metadata before the data is stored in the database. The transformation rules may suggest target repository based on infra manager type and/or object type. The transformation rules may also specify any transformations to be applied to the incoming object messages before the message get persisted.

The inventory provider 608 operates to process inventory requests from one or more orchestration services that may be running in the HC director 160, which are illustrated in FIG. 6 as service 1, service 2 . . . service N. The inventory provider 608 responds to these requests by retrieving relevant inventory updates from the database 610.

The end-to-end object tracking, capturing and mirroring to the HC director 160 by the mirroring system 170 is achieved with the help of a protocol that ties together three different entities, i.e., the change tracker 202, the replicator 204 and the inventory service 206 in the HC director 160. The specifics of the protocol between the different entities are describe below.

As described above, the change tracker 202 relays two different kinds of information to the replicator 204 over the control and data channels 208 and 210 which collectively carry information about the replication stream and the actual object updates. These object updates are part of a sync cycle or Epic. The metadata regarding an Epic includes the identity of the infra manager, e.g., the LNM 124 or the CMC 126, whose object updates are going to be sent. The information regarding the lifecycle of an Epic is conveyed over the control channel 208 in messages, such as the following messages in accordance with an embodiment of the invention.

| Sr# | Message Type | Description | Payload |
|---|---|---|---|
| 1 | START_EPIC | This control message is published | { |
| | | when a full sync starts. This will be | “messageType”: “BEGIN_EPIC”, |
| | | leveraged by replicator to kick | “data”: { |
| | | start the inventory handshake | “epicId”: “<< UUID of Epic >>”, |
| | | process with the HCD. Also, | “infraManagerId”: “<< UUID of |
| | | specifics of infra manager are | LNM/CMC etc >>”, |
| | | recorded and conveyed. | “inventoryType”: “LNM/CMC”, |
| | | | “version”: “<< Version of |
| | | | LNM/CMC >>”, |
| | | | “infraManagerInstanceId”: “<< |
| | | | UUID of LNM/CMC... >>”, |
| | | | “timestamp”: “<< TIMESTAMP >>” |
| | | | } |
| | | | } |
| 2 | LAST_GENERATED_CHANGESET | Change tracker can publish this | { |
| | | message periodically to enable | “messageType”: |
| | | replicator to calculate lag between | “LAST_GENERATED_CHANGES |
| | | changes captured by change tracker | ET”, |
| | | and what has actually been sent to | “data”: { |
| | | the HCD. | “epicId”: “<< Epic ID to which |
| | | | changeset belongs >>”, |
| | | | “infraManagerId”: “<< UUID of |
| | | | LNM/CMC etc >>”, |
| | | | “changeSetId”: “<< The ID of the |
| | | | last changeset published on the data |
| | | | channel >>”, |
| | | | “timestamp”: “<< TIMESTAMP >>” |
| | | | } |
| | | | } |
| 3 | END_EPIC | There are various events which | { |
| | | could cancel an ongoing sync cycle | “messageType”: “END_EPIC”, |
| | | such as: LNM/CMC endpoint | “data”: { |
| | | getting updated/removed from the | “epicId”: “<< UUID of Epic >>”, |
| | | HC manager, connection to these | 1. “infraManagerId”: “<< |
| | | infra manager getting restored. | UUID of LNM/CMC etc |
| | | | >>”, |
| | | | “timestamp”: “<< TIMESTAMP >>” |
| | | | } |
| | | | } |

Object updates of the sync cycle/Epic described above are sent over the data channel 210. An object update of an Epic in accordance with an embodiment of the invention is as follows:

| Sr# | Message Type | Description | Payload |
|---|---|---|---|
| 1 | OBJECT_UPDATE | This message | { |
| | | contains actual object | “messageType”: “OBJECT_UPDATE”, |
| | | update as payload. | “epicId”: “<< UUID of Epic >>”, |
| | | There are three types | “infraManagerId”: “<< UUID of |
| | | of object updates: | LNM/CMC etc >>”, |
| | | Create, Update, | “inventoryType”: “<Infra Mgr Type - |
| | | Delete. During full | LNM/CMC >”, |
| | | sync, only create | “changeSetId”: “< ID of the Object update |
| | | updates are sent. | Changeset >”, |
| | | While delta sync, all | “isLastMessageOfFullSync”: true, |
| | | three types of | “eventType”: “< Type of object update - |
| | | updates could be sent | CREATE/MODIFY/DELETE>”, |
| | | depending on | “entityId”: “< ID of object in the infra |
| | | whether a new object | manager >”, |
| | | was created, existing | “entityType”: “<Type of object - e.g., VM, |
| | | object was modified | Network >”, |
| | | or deleted. | “object”: { |
| | | | “set”: { |
| | | | // Set of object attributes which are to be |
| | | | added/updated |
| | | | }, |
| | | | “unset”: { |
| | | | // Set of object attributes which are to be |
| | | | deleted |
| | | | } |
| | | | } |
| | | | } |

The normalized object updates along with lifecycle events of an Epic are conveyed to the HC director 160 by the replicator 204. Also, the replicator seeks acknowledgement from HC director on the processed object updates using messages of the protocol, such as the following messages in accordance with an embodiment of the invention.

| Sr# | Message Type | Direction | Description | Payload |
|---|---|---|---|---|
| 1 | SYNC_START | Replicator | This control message | { |
| | | to | is published to | “messageType”: |
| | | HCD | inform HCD that | “SYNC_START”, |
| | | | fresh inventory sync | “data”: { |
| | | | cycle is about to | “syncCycleId”: “<< UUID of Sync Cycle. This is |
| | | | begin for a specific | derived from Epic ID >>”, |
| | | | LNM/CMC. This | “timestamp”: “<< TIMESTAMP>>”, |
| | | | event prepares HCD | “siteId”: “<< ID of the site >>”, |
| | | | to receive object | “infraManagerId”: “<< ID/UUID of LNM/CMC |
| | | | updates of the | etc >>”, |
| | | | upcoming sync | “inventoryType”: |
| | | | cycle. | “ LNM/CMC ”, |
| | | | Note that this signal | “version”: “<< Version of LNM/CMC etc >>” |
| | | | processing is | } |
| | | | idempotent on the | } |
| | | | HCD in case it is | |
| | | | received more than | |
| | | | once. | |
| 2 | ACK_SYNC_START | HCD | This message is used | { |
| | | to | by HCD to inform | “messageType”: |
| | | Replicator | replicator about its | “ACK_SYNC_START”, |
| | | | preparedness to | “data”: { |
| | | | receive object | “syncCycleId”: “<< ID from the START_SYNC |
| | | | updates. | message >>”, |
| | | | | “timestamp”: “<< TIMESTAMP >>”, |
| | | | | “siteId”: “<< ID of the site >>”, |
| | | | | “inventoryType”: “<< LNM/CMC..>>”, |
| | | | | “infraManagerId”: “<< ID of LNM/CMC >>” |
| | | | | } |
| | | | | } |
| 3 | REQUEST_LAST_RCVD_CHANGESET | Replicator | Replicator solicits | { |
| | | to | feedback on last | “messageType”: |
| | | HCD | successfully | “REQUEST_LAST_RCVD_CHANGESET”, |
| | | | processed message | “data”: { |
| | | | from HCD by | “requestId”: “<< UUID of request >>”, |
| | | | sending this signal. | “syncCycleId”: “<< ID of active Sync Cycle >>”, |
| | | | | “siteId”: “<< SaaS assigned Site ID >>”, |
| | | | | “inventoryType”: “<< LNM/CMC /.. >>”, |
| | | | | “infraManagerId”: “<< LNM/CMC UUID >>” |
| | | | | } |
| | | | | } |
| 4 | LAST_RCVD_CHANGESET | HCD | This is the response | { |
| | | to | sent by HCD to the | “messageType”: |
| | | Replicator | above request. | “LAST_RCVD_CHANGESET”, |
| | | | This response helps | “data”: { |
| | | | replicator with: | “syncCycleId”: “<< ID of Sync Cycle >>”, |
| | | | 1. Purging object | “requestId”: “<< Req ID from the above request |
| | | | changesets from the | message>>”, |
| | | | DB with ID <= | “changesetId”: “<< ID of last successfully |
| | | | received changeset | received changeset >>”, |
| | | | ID. | “timestamp”: “<< TIMESTAMP >>”, |
| | | | 2. Advance pointer | “siteId”: “<< Site ID >>”, |
| | | | to the next change | “inventoryType”: “<< LNM/CMC..>>”, |
| | | | set from the list | “infraManagerId”: “<< LNM/CMC ID >>” |
| | | | of prefetched | } |
| | | | changesets. | } |
| 5 | FULL_SYNC_COMPLETED | Replicator | This is used to flag | { |
| | | to | HCD that initial | “messageType”: |
| | | HCD | snapshot of all the | “FULL_SYNC_COMPLETED”, |
| | | | objects of a | “data”: { |
| | | | particular infra | “syncCycleId”: “<< ID of Sync Cycle >>”, |
| | | | manager is synced. | “requestId”: “<< UUID >>”, |
| | | | | “timestamp”: “<< TIMESTAMP >>”, |
| | | | | “siteId”: “<< Site ID >>”, |
| | | | | “inventoryType”: “<< LNM/CMC/.. >>”, |
| | | | | “infraManagerId”: “<< LNM/CMC ID >>” |
| | | | | } |
| | | | | } |
| 6 | ACK_FULL_SYNC_COMPLETED | HCD | HCD responds with | { |
| | | to | this message to | “messageType”: |
| | | Replicator | inform replicator | “ACK_FULL_SYNC_COMPLETED |
| | | | that HCD is prepared | ”, |
| | | | to received | “data”: { |
| | | | subsequent | “syncCycleId”: “<< ID of Sync Cycle >>”, |
| | | | differential object | “requestId”: “ << Req ID from the above request |
| | | | changes | message >>”, |
| | | | | “timestamp”: “<< TIMESTAMP >>”, |
| | | | | “siteId”: “<< Site ID >>”, |
| | | | | “inventoryType”: “<< LNM/CMC/.. >>”, |
| | | | | “infraManagerId”: “<< LNM/CMC ID >>” |
| | | | | } |
| | | | | } |
| 7 | SYNC_END | Replicator | This is typically sent | { |
| | | to | upon receiving | “messageType”: “SYNC_END”, |
| | | HCD | END_EPIC signal | “data”: { |
| | | | from the change | “syncCycleId”: “<< UUID of Sync Cycle derived |
| | | | tracker. This signal | from Epic ID >>”, |
| | | | allows HCD to | “timestamp”: “<< TIMESTAMP >>”, |
| | | | invalidate already | “siteId”: “<< Site ID >>”, |
| | | | synced inventory | “inventoryType”: “<< LNM/CMC/.. >>”, |
| | | | objects. | “infraManagerId”: “<< |
| | | | | LNM/CMC UUID >>” |
| | | | | } |
| | | | | } |
| 8 | OBJECT_UPDATE | Replicator | Multiple object | { |
| | | to | updates of the same | “messageType”: |
| | | HCD | sync cycle are | “OBJECT_UPDATE”, |
| | | | packaged in the | “syncCycleId”: “<< ID of sync cycle >>”, |
| | | | same message to | “inventoryType”: “<< LNM/CMC /.. >>”, |
| | | | allow for faster | “infraManagerId”: “<< LNM/CMC UUID >>”, |
| | | | transfer | “changesets”: [{ |
| | | | | “changeSetId”: 101, |
| | | | | “eventType”: |
| | | | | “CREATE/UPDATE/DELETE”, |
| | | | | “entityId”: “<< ID of Object >>”, |
| | | | | “entityType”: “<< Object Type >>”, |
| | | | | “object”: { |
| | | | | “set”: { |
| | | | | // Set of object attributes which are to be |
| | | | | added/updated |
| | | | | }, |
| | | | | “unset”: { |
| | | | | // Set of object attributes which are to be deleted |
| | | | | } |
| | | | | } |
| | | | | }] |
| | | | | } |

Turning now to FIG. 7, a diagram of a replication process showing an end-to-end flow of control and data messages from one or more inventory sources (e.g., the logical network manager 124 and the cluster management center 126) to the change tracker 202, the replicator 204 and the inventory service 206 in the HC director 160 in accordance with an embodiment of the invention is illustrated. In FIG. 2, the change tracker 202 is shown with a LNM plugin 702 and an CMC plugin 704, which communicate with the LNM 124 and the CMC 126, respectively, to receive current information about the objects being managed by each of these infra managers.

The process begins at step 1, where an EPIC_START message is sent from the change tracker 202 to the state controller 402 of the replicator 204 though the control channel 208. In addition, an object update (i.e., changeset) is sent from the change tracker 202 to the data collector 404 of the replicator 204 though the data channel 210. Next, at step 2, the active Epic ID for a particular infra manager is persistently stored in the database 408 by the state controller 402. In addition, the object update for the Epic is persistently stored in the database 408 by the data collector 404. At step 3, stale change sets for an infra manager, where EPIC ID!=EPIC ID from the control message, is purged by the state controller 402.

Next, at step 4, a SYNC_START message is published to the inventory service 206 in the HC director 160 by the inventory publisher 406 of the replicator 204. At step 5, the active EPIC ID for a particular infra manager is persistently stored in the database by the inventory service. At step 6, stale inventory objects for the infra manager are invalidated by the inventory service 206.

Next, at step 7, an ACK_SYNC_START message is transmitted to the inventory publisher 406 from the inventory service 206. At step 8, predefined object updates are transmitted to the inventory service 206 from the inventory publisher 406. These predefined object updates are updates with change set IDs greater than last change set ID received/acknowledged by the inventory service 206 and up to max allowed, i.e., not limited. Next, at step 9, a REQUEST_LAST_CHANGESET_RECEIVED message is transmitted to the inventory publisher 406 from the inventory service 206. At step 10, updates are persistently stored in the database 610 and changeset ID of the last message is noted by the inventory service 206.

Next, at step 11, an ACK_MSG_RECEIVED message is transmitted to the inventory publisher 406 from the inventory service 206. At step 12, changeset ID is updated in the database 408 by the inventory publisher 406 as the one acknowledged by the inventory service 206. In addition, all changeset IDs less than the one acknowledged by the inventory service 206 are purged in the database 408 by the inventory publisher 406.

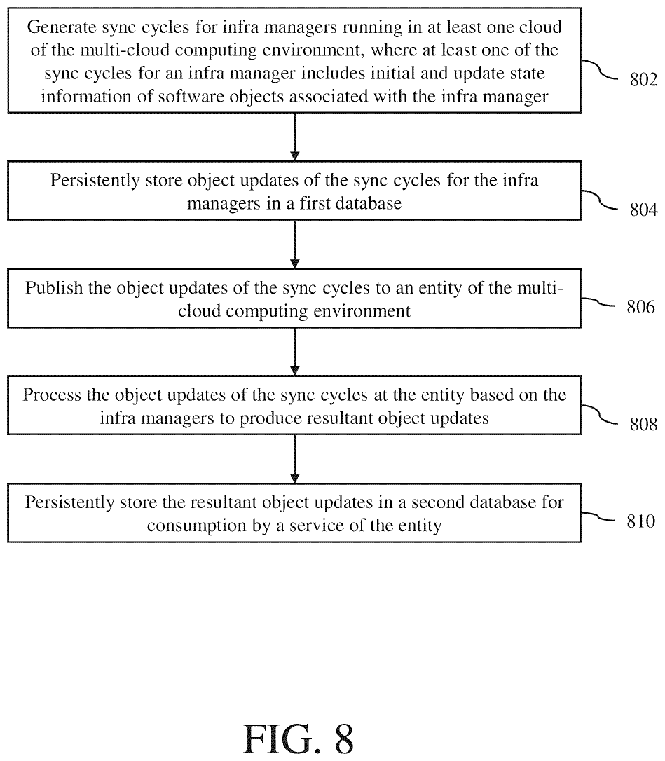

A computer-implemented method for managing software objects in a multi-cloud computing environment, such as the cloud system 100, in accordance with an embodiment of the invention is described with reference to a process flow diagram of FIG. 8. At block 802, sync cycles for infra managers running in at least one cloud of the multi-cloud computing environment are generated, where at least one of the sync cycles for an infra manager include initial and update state information of software objects associated with the infra manager. At block 804, object updates of the sync cycles for the infra managers are persistently stored in a first database. At block 806, the object updates of the sync cycles are published to an entity of the multi-cloud computing environment. At block 808, the object updates of the sync cycles are processed at the entity based on the infra managers to produce resultant object updates. At block 810, the resultant object updates are persistently stored in a second database for consumption by a service of the entity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for managing software objects in a multi-cloud computing environment, the method comprising:
generating sync cycles for infra managers running in at least one cloud of the multi-cloud computing environment, at least one of the sync cycles for an infra manager including initial and update state information of software objects associated with the infra manager;
persistently storing object updates of the sync cycles for the infra managers in a first database;
publishing the object updates of the sync cycles to an entity of the multi-cloud computing environment;
processing the object updates of the sync cycles at the entity based on the infra managers to produce resultant object updates; and
persistently storing the resultant object updates in a second database for consumption by a service of the entity.

2. The method of claim 1, wherein publishing the object updates of the sync cycles includes limiting the number of the object updates published to the entity based on the number of unacknowledged object updates published to the entity.

3. The method of claim 2, wherein limiting the number of the object updates includes limiting the number of the object updates published to the entity such that an identification of an object update minus an identification of acknowledged object update is equal to or less than a maximum number of unacknowledged object updates allowed.

4. The method of claim 1, wherein publishing the object updates of the sync cycles includes transmitting a set of object updates and waiting for an acknowledgement of an identification of an object update most recently received by the entity.

5. The method of claim 1, wherein generating the sync cycles for infra managers includes exclusively carrying lifecycle information of the sync cycles in a control channel and exclusively carrying the object updates in a data channel.

6. The method of claim 1, wherein processing the object updates of the sync cycles at the entity includes applying transformation rules on the object updates to produce resultant object updates.

7. The method of claim 1, further comprising processing messages from a cloud of the multi-cloud computing environment associated with the object updates of the sync cycles at the entity to purge inventory of objects of a decommissioned infra manager or record information about a new sync cycle for a particular infra manager.

8. The method of claim 1, wherein the service of the entity is a workload migration service.

9. A non-transitory computer-readable storage medium containing program instructions for managing software objects in a multi-cloud computing environment, wherein execution of the program instructions by one or more processors causes the one or more processors to perform steps comprising:
generating sync cycles for infra managers running in at least one cloud of the multi-cloud computing environment, at least one of the sync cycles for an infra manager including initial and update state information of software objects associated with the infra manager;
persistently storing object updates of the sync cycles for the infra managers in a first database;
publishing the object updates of the sync cycles to an entity of the multi-cloud computing environment;
processing the object updates of the sync cycles at the entity based on the infra managers to produce resultant object updates; and
persistently storing the resultant object updates in a second database for consumption by a service of the entity.

10. The non-transitory computer-readable storage medium of claim 9, wherein publishing the object updates of the sync cycles includes limiting the number of the object updates published to the entity based on the number of unacknowledged object updates published to the entity.

11. The non-transitory computer-readable storage medium of claim 10, wherein limiting the number of the object updates includes limiting the number of the object updates published to the entity such that an identification of an object update minus an identification of acknowledged object update is equal to or less than a maximum number of unacknowledged object updates allowed.

12. The non-transitory computer-readable storage medium of claim 9, wherein publishing the object updates of the sync cycles includes transmitting a set of object updates and waiting for an acknowledgement of an identification of an object update most recently received by the entity.

13. The non-transitory computer-readable storage medium of claim 9, wherein generating the sync cycles for infra managers includes exclusively carrying lifecycle information of the sync cycles in a control channel and exclusively carrying the object updates in a data channel.

14. The non-transitory computer-readable storage medium of claim 9, wherein processing the object updates of the sync cycles at the entity includes applying transformation rules on the object updates to produce resultant object updates.

15. The non-transitory computer-readable storage medium of claim 9, wherein the steps further comprise processing messages from a cloud of the multi-cloud computing environment associated with the object updates of the sync cycles at the entity in the second cloud to purge inventory of objects of a decommissioned infra manager or record information about a new sync cycle for a particular infra manager.

16. The non-transitory computer-readable storage medium of claim 9, wherein the service of the entity is a workload migration service.

17. A system comprising:
memory; and
one or more processors configured to:
generate sync cycles for infra managers running in at least one cloud of the multi-cloud computing environment, at least one of the sync cycles for an infra manager including initial and update state information of software objects associated with the infra manager;
persistently store object updates of the sync cycles for the infra managers in a first database;
publish the object updates of the sync cycles to an entity of the multi-cloud computing environment;
process the object updates of the sync cycles at the entity based on the infra managers to produce resultant object updates; and
persistently store the resultant object updates in a second database for consumption by a service of the entity.

18. The system of claim 17, wherein the one or more processors are configured to limit the number of the object updates published to the entity based on the number of unacknowledged object updates published to the entity.

19. The system of claim 18, wherein the one or more processors are configured to limit the number of the object updates published to the entity such that an identification of an object update minus an identification of acknowledged object update is equal to or less than a maximum number of unacknowledged object updates allowed.

20. The system of claim 17, wherein the one or more processors are configured to exclusively transmit lifecycle information of the sync cycles in a control channel and exclusively transmit the object updates in a data channel.
